(19) United States
(12) Patent Application Publication
(10) Pub. No.: US 2010/0332333 A1
(43) Pub. Date: Dec. 30, 2010

(54) DIET CONTROL METHOD

(76) Inventor: Marc Neff, Cherry Hill, NJ (US)

Correspondence Address: ITALIA IP, 3500 WEST OLIVE AVE., SUITE 300, BURBANK, CA, 91505, US

(21) Appl. No.: 12/492,691

(22) Filed: Jun. 26, 2009

(51) Int. Cl. G06Q 50/00; G06Q 30/00; G06Q 20/00

(52) U.S. Cl. 705/15; 705/21; 705/17

(57) ABSTRACT

A device and system which have capability of inhibiting food purchases. The system analyzes proposed food purchases for adherence to a pre-established dietary regimen. If a proposed purchase fails to conform to the dietary regimen, the device may inhibit authorization of payment of funds for the proposed purchase. The device and system may comprise an electronic payment device such as a credit or debit card, or a portable image capture device such as a cellular telephone having camera capability for example. The device may be self-contained or alternatively, may work in conjunction with a remote station, such as a data processing station linked to the device by a communications channel.

### FIELD OF THE INVENTION

The present invention pertains to use of a credit card type device in controlling dietary practices. The card processes data pertaining to dietary choices in restaurants and prevents authorizing payment funds should calorie values exceed predetermined thresholds.

### BACKGROUND OF THE INVENTION

Undesirable weight gain to the point of morbid obesity is a rising threat to health among many people today. Efforts to counter weight gain, such as dieting and physical workouts may or may not prevent undesirable weight gain. One of the more effective ways of countering weight gain is controlling diet. This requires that the dieter know in advance the calorie count of many types of foods, which may be beyond the abilities of most people. Also, there is the matter of maintaining a running total of calories consumed each day. A permissible threshold may be passed not at the first meal, but at a subsequent meal or during snacking throughout the day. Even beyond that, there is the matter of the quality of consumed food. Some foods may contain calorie counts which in and of themselves may be objectionable, but may be offset by other nutritional factors.

The same may hold true for other dietary aspects, such as monitoring sodium intake, sugar intake, and other objectionable ingredients. It may also be desirable to restrict food intake to foods known to have certain desirable characteristics, such as relative or absolute amounts of fat, protein, sugars, fiber, minerals and vitamins, and the like.

Most people today rely on restaurants, such as so-called fast food restaurants, for a significant percentage of food. It may not be easy to select the most desirable food types at such restaurants. It is also difficult to remain aware of and monitor the many aspects of food intake when dining at restaurants.

There exists a need for a way to monitor dietary intake throughout the day and to impose an inhibition to undesirable food intake throughout the day.

### SUMMARY OF THE INVENTION

The present invention provides a way of monitoring and controlling dietary intake when the user relies on purchased food. Briefly, a novel system is proposed wherein a data processing device such as for example a credit card, debit card, or business membership card can keep track of food purchases or proposed purchases internally. Exceeding predetermined thresholds regarding calorie count or other undesirable aspects of food may trigger denial of purchase abilities or privileges. For example, a credit or debit card could inhibit authorization of a transaction to pay for food deemed objectionable.

In a further aspect of the invention, the novel system could employ a communications device such as an iPhone® or any internet enabled personal communications device. Images may be captured by the device and submitted to optical or other analysis at a remote station, which would then send an enabling signal or inhibition signal which would be processed by the card.

The novel system may therefore be limited to a single card type device carried by the user, or may be expanded to include a personal communications device and a central station for processing data and issuing commands.

Resultant decision making regarding food content becomes the basis for causing the card type device to ultimately control the purchase by selectively enabling food purchases which conform to predetermined standards and denying food purchases which do not conform to the predetermined standards.

### BRIEF DESCRIPTION OF THE DRAWINGS

Similar reference characters denote corresponding features consistently throughout the attached drawings.

FIG. 1 is a perspective view of a retail establishment at which food purchases may be controlled according to at least one aspect of the invention.

FIG. 2 is a diagrammatic view of apparatus including a remote station, which may be used to implement control of food purchases according to at least one aspect of the invention.

FIG. 3 is a diagrammatic side view of a portable communications device which may be used to implement control of food purchases according to at least one aspect of the invention.

FIG. 4 is a block diagram of steps of a method which may be performed in controlling food purchases according to at least one aspect of the invention.

### DETAILED DESCRIPTION

The present invention sets forth method of and apparatus for controlling food purchases to oblige a person to conform to a predetermined dietary regimen. Food purchases are controlled by selectively authorizing and refusing authorization of electronic payment for proposed food purchases at restaurants for example.

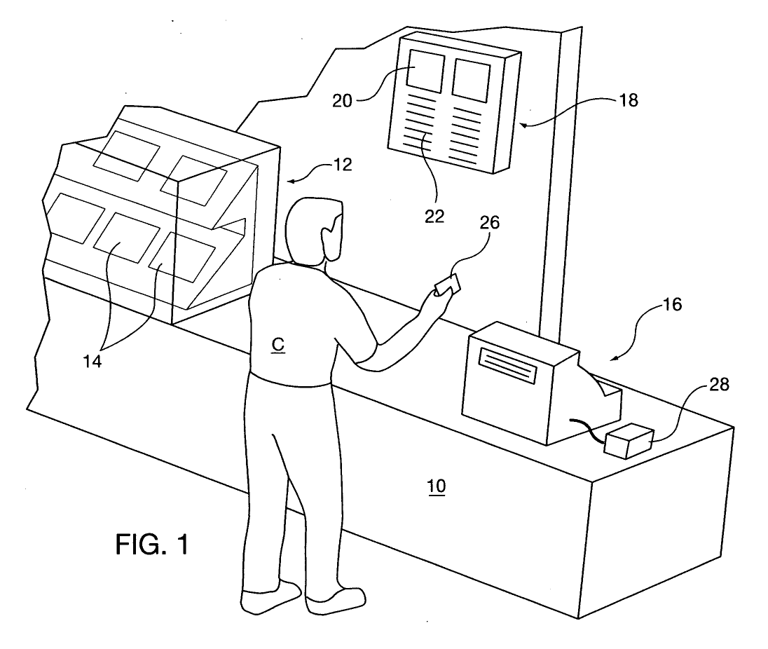

FIG. 1 shows a customer C standing at a check-out line of a restaurant. The restaurant has a food counter 10, a transparent cabinet 12 for displaying food selections 14 which may be removed for purchase by customers, and a cash register 16 which will be understood to include a credit or debit card processor 28 which can process payment by swiping and reading the card for example. The restaurant may have a display menu 18 bearing images 20 of food or written description or listings 22 of food selections, which may include the food selections 14 and others, for example, which are available for purchase at the restaurant. The cash register 16 may have a display 24 for displaying purchases and proposed purchases. The customer C is shown proffering a payment card 26 in preparation to pay for food selections. The payment card 26 may be a credit card or a debit card for example, of the type which authorizes transfer of funds electronically.

The customer C may have established a predetermined dietary regimen for example to promote weight control, health, and other objectives. The dietary regimen includes parameters regarding quantities and characteristics of food which parameters may apply to food being purchases on a day-by-day basis for example. The dietary regimen may be directed to calorie content of foods, fat content, sugar content, sodium content, or other content of foods. The regimen may require that minimum quantities of certain nutrients such as protein be present in food selections. Quantities, such as portion size, may be encompassed by the dietary regimen. Specific ingredients or substances contained within an ideal diet may be permitted at controlled rates of intake. For example, the dietary regimen may consider calories per hour as well as total calories for a day's consumption. Undesirable food ingredients such as fat, salt or sodium, and sugar, may be limited as to a daily maximum. Necessary food ingredients such as protein, fiber, specified vitamins, minerals, and other chemicals, and others may be required in certain quantities over time, such as per day. For example, the predetermined dietary regimen may contain a parameter which promotes a predetermined threshold of protein intake over a predetermined time interval. Regardless of the specifics of the dietary regimen, the parameters of acceptability and unacceptability may be maintained in an electronic record which is in communication with the payment authorization apparatus comprising in this example the cash register 16, the payment card 26, and the credit or debit card processor 28.

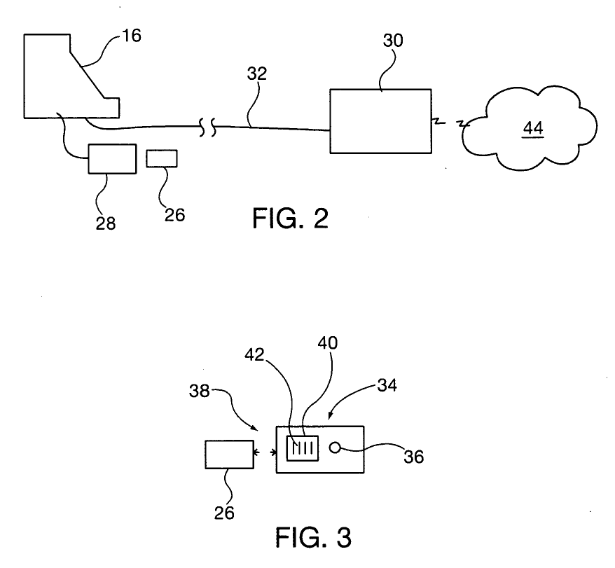

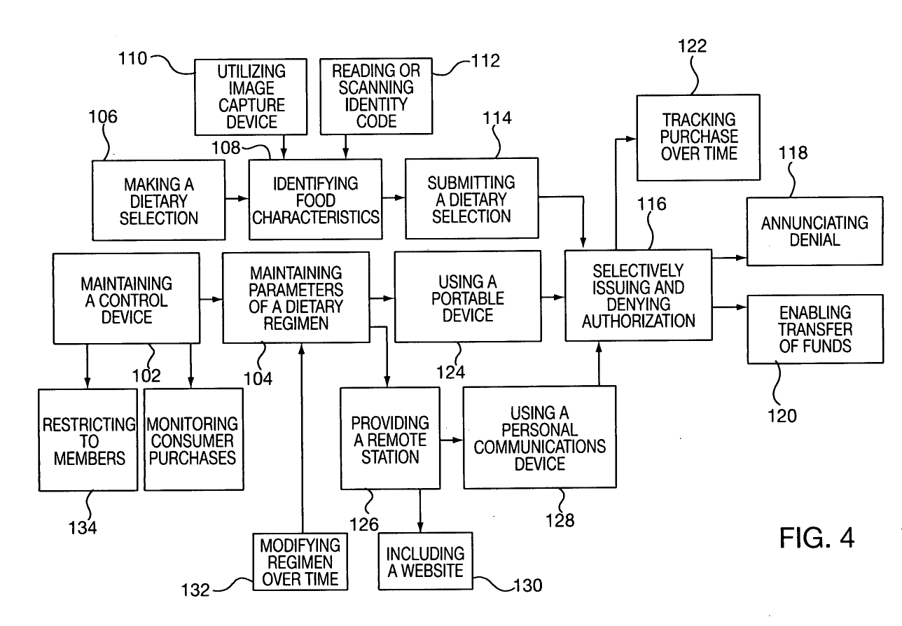

The electronic record may be stored for example in a remote computer 30 (see FIG. 2) such as a personal computer or a server. The remote computer 30 may be placed in communication with the cash register 16 and the payment card 26 by a communications channel 32. The communications channel 32 may comprise the internet, telephone land lines, wireless links, mobile telephone devices, and the like.

The actual selections of the customer C may be identified, submitted or communicated to the remote computer 30, and analyzed for conformity to the predetermined dietary regimen. The system may then selective issue purchase authorizations when the dietary selection conforms to the predetermined dietary regimen and deny purchase authorizations when a dietary selection fails to conform to the predetermined dietary regimen. Authorizations will be understood to remove inhibitions which would obstruct transfer of funds and hence terminate the attempted purchase of food, where these inhibitions relate to assessment of conformity to the dietary regimen. Other inhibitions such as credit standing, availability of funds in a debit account, exercise of the payment card 26 by authorized personnel, etc. may still come into play even if conformity to the dietary regimen is satisfied.

It should be stressed at this point that the invention does not necessarily reside in any specific apparatus to accomplish the above process, although in some aspects, apparatus may be regarded as falling within the scope of the invention. The invention may reside in a method 100, the steps of which are summarized in FIG. 3. The method 100 is a method of controlling food purchases to oblige a person to conform to a predetermined dietary regimen. The method 100 may comprise a step 102 of maintaining available to a person attempting to conform to the predetermined dietary regimen, such as the customer C, a control device such as the payment card 26, having data processing capability including parameters of the predetermined dietary regimen and ability to accept and deny purchase authorization. It should be understood that part of the decision making process may be carried out remotely, such as by the remote computer 30, so that parameters of the dietary regimen need not literally be carried within the payment card 26. However, the payment card 26 must have ability to satisfy ordinary requirement of conventional point-of-sale transactions which are implemented electronically. Therefore, for the purposes of this disclosure, a control device may comprise a conventional payment card or alternatively a payment card that has internal ability to contribute to the process of assessing and selectively enabling or denying authorization. Remote complementing apparatus such as the remote computer 30 are encompassed within the term control device where necessary for operability.

The method 100 may comprise a step 104 of establishing and maintaining parameters of a dietary regimen, as has been described above.

As the method 100 is implemented at food establishments which offer electronic payment processing, the method 100 may comprise a step 106 of making a dietary selection at a commercial food establishment, such as the restaurant depicted in FIG. 1. However, it will be appreciated that the food establishment need not literally be a commercial food establishment such as a for-profit restaurant. The food establishment may be for example a cafeteria operated by a school, employer, or other organizations. As employed herein, the term “commercial” will be understood to refer to electronic processing of food selections in the manner of point-of-sale purchases. The electronic processing may merely account for a prepaid food allotment for example. Illustratively, a prepaid food plan of a school or other institution, employer, military establishment, and the like may be operated merely to assure that each participant does not exceed his or her allotment of food over a time period.

The method 100 may comprise a step 108 of identifying nature and characteristics of food selections. This may comprise merely identifying the food, such as recognizing that a selection comprises a hamburger or other food of known characteristics, or may comprise deeper analysis of specific foods. This may be done in several ways. For example, the payment authorization apparatus may comprise a personal communications device such as a mobile telephone 34 having an integral image capture device such as a camera 36. Commercial products such as the iPhone® exemplify such personal communications devices. Alternatively, the personal communications device may comprise a dedicated device having capability to communicate with the payment card 26, such as a card receiving slot and reader 38.

Regardless of whether the payment authorization apparatus comprises a dedicated device or a standard personal communications device, it may comprise a display 40 on which may be displayed messages. The display 40 may display indicia 42 corresponding to a message related to the novel method 100. For example, the indicia 42 may comprise a notice that a proposed purchase has been declined for failure to conform to the pre-established dietary regimen. Other exemplary messages could comprise running totals of daily caloric intake, and running totals of nutrients or of undesirable substances such as fat, sugar, and salt, or combinations of any of these.

Returning to the method 100, the step 108 of identifying food characteristics may comprise a step 110 of utilizing an image capture enabled communications device such as the mobile telephone 34 and analyzing the captured images of the food to determine identity of the food for which a purchase authorization is being submitted. Of course, identity of the food may be limited to recognition of constituent food substances contained therein. This may be done by analyzing images of the food which images have been captured by the camera 36 for conformity of the food to the predetermined dietary regimen. Alternatively, the step 106 may comprise a step 112 of reading or scanning a pre-established identity code imposed on a food product to determine identity of the food and conformity of the food to the predetermined dietary regimen. For example, a retailer's SKU number or a manufacturer's bar coded product identifying number may be read by capturing an image thereof or by direct scanning. Direct scanning implies that the payment authorization apparatus, which may be a portable communications device, may incorporate a scanner adapted to the particular technology by which a SKU or bar coded number is presented.

Once the content of the selected food has been determined, the nature or characteristics of the food are submitted to the control device. This is shown as a step 114 of submitting the dietary selection, or the food selection, to the control device. In this step, the nature and characteristics of the dietary selection are transmitted to that device, such as the remote computer 30, which compares the nature and characteristics of the dietary selection to the parameters of the pre-established dietary regimen.

This comparison yields one of two outcomes, those of determining that consumption of the proposed food selection will result in conforming to the predetermined dietary regimen, or that consumption will fail to conform thereto. The method 100 therefore may comprise a decision step 116 of selectively issuing purchase authorizations when the dietary selection conforms to the predetermined dietary regimen and denying purchase authorizations when the dietary selection fails to conform to the predetermined dietary regimen.

Should purchase authorization be withheld due to failure to conform to the predetermined dietary regimen, the step 116 may be accompanied by a step 118 of annunciating a denial of a proposed food purchase using audiovisual output of the personal communications device when a proposed food purchase is judged as not conforming to the predetermined dietary regimen. Such a step 118 may for example reflect the indicia 42, which may comprise a notice that a proposed purchase has been declined.

If, on the other hand, the dietary selections continue to conform to the predetermined dietary regimen, then the method 100 may comprise a step 120 of enabling transfer of funds in payment of purchased food to the food establishment at which each dietary selection is submitted. This occurs of course where the method 100 is being practiced at a location requiring immediate payment, such as a restaurant.

It will be appreciated that reaching daily thresholds for intake of specific food components may require more than one meal. To accommodate this situation, the system, as administered by the remote computer 30 for example, may keep cumulative count of all food components being monitored for conformity to the predetermined dietary regimen. The method 100 may therefore comprise a step 122 of causing the control device to keep track of purchases throughout a time interval, such as one calendar day, and to maintain cumulative count of characteristics of purchased food such that the cumulative count may serve to establish a threshold of acceptability of subsequent proposed food purchases during that day.

The method 100 may be implemented in several ways. For example, much or all of the necessary data processing may be performed in a portable device such as the mobile telephone 34, when provided with suitable software. Such software could maintain the parameters of the predetermined dietary regimen and to carry out the decision making step 116. Therefore, the method 100 may comprise a step 124 of causing the control device to maintain the parameters of the predetermined dietary regimen in a portable device and to have ability to make internally decisions to authorize and to deny purchase authorizations.

As an alternative, the system administering the method 100 may rely upon a remote station such as the remote computer 30 which communicates with a personal communications device located at the point of sale, such as the mobile telephone 34. In this situation, the control device will be understood to include the payment card 26 and optionally the cash register 16. In such cases, the decision making step 116 may be performed at the remote station, with the results transmitted back to the control device by a personal communications device such as the mobile telephone 34. Accordingly, the method 100 may comprise the further step 126 of providing a remote station to maintain the parameters of the predetermined dietary regimen and to have ability to make decisions to authorize and to deny purchase authorizations, and a step 128 of utilizing a personal communications device and a communications channel to communicate between the control device and the remote station so as to collectively implement the authorization process wherein dietary selections are submitted to the control device and decisions are made to authorize and deny purchase authorizations. Either the option for a self-contained device, as reflected in the step 124, or for using a remote station which communicates to the point of sale, as reflected in the steps 126 and 128, may be used to implement the decision making step 116. Where a remote station is used, the system may tie into an internet website 44 (see FIG. 2). The website 44 may be understood to include an associated server (not shown) which may act in the capacity of the remote computer 30 for example. The website 44 may also serve as a lookup table for obtaining data related to food ingredients, such as caloric, salt, sugar, fat, and protein content for example. The method 100 may therefore comprise a step 130 of including a website on the internet which is accessible to assist in implementing the method 100.

Many times, dietary needs change over time. To accommodate these situations, the method 100 may comprise a step 132 of modifying the predetermined dietary regimen over time in light of changing conditions.

The present invention may be practiced by businesses which offer dietary control to customers as a service. To accommodate such businesses, the control device may be issued only to those who enroll in a membership program operated by such a business. The method 100 may therefore comprise a step 134 of issuing a membership card issuance of which is restricted to members enrolled in a membership program operated by a commercial establishment.

Regardless of formal membership, a commercial establishment such as a business may wish to monitor purchases by individual consumers participating in dietary control such as by using the method 100. The method 100 may therefore comprise a step 136 of operating a discount arrangement operated by a commercial establishment administering dietary control using the method 100, which discount arrangement digitally monitors purchases of individual consumers of that commercial establishment.

The method 100 may include any of the steps listed above, and may modify the method 100 as presented, for example by deleting one or more steps where feasible. The order in which the steps are practiced may vary from the order described herein.

The invention may also be thought of as a control device for controlling food purchases to oblige a person to conform to a predetermined dietary regimen. More specifically, the control device may comprise a hand held data processing control device having apparatus and software which are operable to execute at least in part a process of controlling food purchases by analyzing proposed food purchases for conformity to at least one parameter of the predetermined dietary regimen and by issuing commands to accept and deny purchase authorization based on the analysis of proposed food purchases. The hand held data processing control device may be for example, a mobile telephone 34 as shown in FIG. 3, provided that appropriate software has been incorporated thereinto.

The invention may also be thought of as a system for controlling food purchases to oblige a person to conform to a predetermined dietary regimen. The system may comprise a hand held data processing control device, a central station for processing data and issuing commands, and a personal communications device. The hand held data processing control device may comprise apparatus and software which are operable to execute at least in part a process of controlling food purchases by analyzing proposed food purchases for conformity to at least one parameter of the predetermined dietary regimen and by issuing commands to accept and deny purchase authorization based on the analysis of proposed food purchases. The hand held data processing control device may be integrated with the personal communications device. The personal communications device may be a device which is enabled to communicate over a communications channels, and which is disposed to communicate signals between said hand held data processing device and said central station so as to assist in implementing the a process of controlling food purchases. The personal communications device may perform only communications functions, only annunciation functions, or both, or alternatively may have memory and data processing hardware and software so as to actively participate in data handling and decision making as set forth herein. The personal communications device may be any known hand held electronic communications device, such as a mobile telephone.

The central station may comprise apparatus and software which are operable to execute at least in part a process of controlling food purchases by analyzing proposed food purchases for conformity to at least one parameter of the predetermined dietary regimen and by issuing commands to accept and deny purchase authorization based on the analysis of proposed food purchases, such as the remote computer 30.

While the present has been described in connection with what is considered the most practical and preferred embodiments, it is to be understood that the present invention is not to be limited to the disclosed arrangements, but is intended to cover various arrangements which are included within the spirit and scope of the broadest possible interpretation of the appended claims so as to encompass all modifications and equivalent arrangements which are possible.

I claim:

1. A method of controlling food purchases to oblige a person to conform to a predetermined dietary regimen, comprising the steps of:
maintaining available to a person attempting to conform to the predetermined dietary regimen a control device having data processing capability including parameters of the predetermined dietary regimen and ability to accept and deny purchase authorization;
making a dietary selection at a commercial food establishment;
submitting the dietary selection to the control device; and
selectively issuing purchase authorizations when the dietary selection conforms to the predetermined dietary regimen and denying purchase authorizations when the dietary selection fails to conform to the predetermined dietary regimen.

2. The method of claim 1, comprising the further step of causing the control device to keep track of purchases throughout a time interval and to maintain cumulative count of characteristics of purchased food such that the cumulative count may serve to establish a threshold of acceptability of subsequent proposed food purchases.

3. The method of claim 1, wherein the step of selective issuing purchase authorizations and denying purchase authorizations comprises the further step of enabling transfer of funds in payment of purchased food to the food establishment at which each dietary selection is submitted.

4. The method of claim 1, comprising the further step of causing the control device to maintain the parameters of the predetermined dietary regimen in a portable device and to have ability to make internally decisions to authorize and to deny purchase authorizations.

5. The method of claim 1, comprising the further steps of:
providing a remote station to maintain the parameters of the predetermined dietary regimen and to have ability to make decisions to authorize and to deny purchase authorizations; and
utilizing a personal communications device and a communications channel to communicate between the control device and the remote station so as to collectively implement the authorization process wherein dietary selections are submitted to the control device and decisions are made to authorize and deny purchase authorizations.

6. The method of claim 5, wherein the step of utilizing a personal communications device comprises the further steps of:
utilizing an image capture enabled communications device to capture images of food for which a purchase authorization is being submitted; and
analyzing the captured images of the food to determine identity of the food and conformity of the food to the predetermined dietary regimen.

7. The method of claim 1, comprising the further step of using a pre-established identity code imposed on a food product to determine identity of the food and conformity of the food to the predetermined dietary regimen.

8. The method of claim 5, comprising the further step of annunciating a denial of a proposed food purchase using audiovisual output of the personal communications device when a proposed food purchase is judged as not conforming to the predetermined dietary regimen.

9. The method of claim 5, wherein the remote station includes a website on the internet which is accessible to assist in implementing the method of claim 5.

10. The method of claim 1, wherein the predetermined dietary regimen contains a parameter limiting calorie content based on food intake over a predetermined time interval.

11. The method of claim 1, wherein the predetermined dietary regimen contains a parameter which limits fat intake over a predetermined time interval.

12. The method of claim 1, wherein the predetermined dietary regimen contains a parameter which limits sugar intake over a predetermined time interval.

13. The method of claim 1, wherein the predetermined dietary regimen contains a parameter which promotes a predetermined threshold of protein intake over a predetermined time interval.

14. The method of claim 1, wherein the predetermined dietary regimen contains a parameter which limits sodium intake over a predetermined time interval.

15. The method of claim 1, comprising the further step of modifying the predetermined dietary regimen over time.

16. The method of claim 1, wherein the control device comprises a card issuance of which is restricted to members enrolled in a membership program operated by a commercial establishment.

17. The method of claim 1, wherein the control device is part of a discount arrangement operated by a commercial establishment, which discount arrangement digitally monitors purchases of individual consumers of that commercial establishment.

18. A control device for controlling food purchases to oblige a person to conform to a predetermined dietary regimen, comprising a hand held data processing control device having apparatus and software which are operable to execute at least in part a process of controlling food purchases by analyzing proposed food purchases for conformity to at least one parameter of the predetermined dietary regimen and by issuing commands to accept and deny purchase authorization based on the analysis of proposed food purchases.

19. A system device for controlling food purchases to oblige a person to conform to a predetermined dietary regimen, comprising:
a hand held data processing control device having apparatus and software which are operable to execute at least in part a process of controlling food purchases by analyzing proposed food purchases for conformity to at least one parameter of the predetermined dietary regimen and by issuing commands to accept and deny purchase authorization based on the analysis of proposed food purchases;
a central station for processing data and issuing commands, having apparatus and software which are operable to execute at least in part a process of controlling food purchases by analyzing proposed food purchases for conformity to at least one parameter of the predetermined dietary regimen and by issuing commands to accept and deny purchase authorization based on the analysis of proposed food purchases; and
a personal communications device which is enabled to communicate over a communications channels, and which is disposed to communicate signals between said hand held data processing device and said central station so as to assist in implementing the a process of controlling food purchases.
